(19) United States
(12) Patent Application Publication
(10) Pub. No.: US 2026/0093346 A1
(43) Pub. Date: Apr. 2, 2026

(54) HUMAN-COMPUTER INTERACTION METHOD, ELECTRONIC DEVICE AND NON-TRANSIENT COMPUTER-READABLE STORAGE MEDIUM

(71) Applicant: Beijing Zitiao Network Technology Co., Ltd., Beijing (CN)

(72) Inventors: Jie YANG, Beijing (CN); Mingkun MU, Beijing (CN); Weihuang YANG, Beijing (CN); Chi WANG, Beijing (CN)

(21) Appl. No.: 19/342,209

(22) Filed: Sep. 26, 2025

(30) Foreign Application Priority Data
Sep. 27, 2024 (CN) 202411365713.8

(51) Int. Cl. G06F 3/0346; G06F 3/04847

(52) U.S. Cl. CPC G06F 3/0346; G06F 3/04847

(57) ABSTRACT

The embodiments of the present disclosure provide a human-computer interaction method, an electronic device and a non-transient computer-readable storage medium. The method includes: displaying first media data in a first interface, wherein the first media data is media data that is currently playing; determining object motion information according to device posture data transmitted by a posture data acquisition device in response to a starting operation of a first service, wherein the first service includes interaction configuration information, and the interaction configuration information represents candidate object motion information and a candidate interaction mode; determining a first interaction mode according to the object motion information and the interaction configuration information, and performing an interactive operation on the first media data according to the first interaction mode.

### CROSS-REFERENCE TO RELATED APPLICATION

The present disclosure claims the priority and benefits of Chinese patent application No. 202411365713.8 entitled “HUMAN-COMPUTER INTERACTION METHOD, APPARATUS, DEVICE, MEDIUM AND PROGRAM PRODUCT” and filed in Chinese Patent Office on Sep. 27, 2024, the entirety of which is incorporated into the present disclosure by reference.

### TECHNICAL FIELD

Embodiments of the present disclosure relate to a human-computer interaction method, an electronic device and a non-transient computer-readable storage medium.

### BACKGROUND

At present, with the development of computer and network technologies, more and more users watch videos on video platforms. Here, the video platform may be a video application or the like.

After the user terminal starts the video application, the user terminal can receive video streams pushed by the transmission server and play any video in the video streams. In the process of video playback, users can turn the video pages by sliding their fingers up and down on the screen. However, in the above scheme, the user maintains the same posture for a long time, which is likely to cause physical fatigue.

### SUMMARY

In an aspect, the embodiments of the present disclosure provide a human-computer interaction method, comprising:
displaying first media data in a first interface, wherein the first media data is media data that is currently playing;
determining object motion information according to device posture data transmitted by a posture data acquisition device in response to a starting operation of a first service, wherein the first service includes interaction configuration information, and the interaction configuration information represents candidate object motion information and a candidate interaction mode;
determining a first interaction mode according to the object motion information and the interaction configuration information, and performing an interactive operation on the first media data according to the first interaction mode.

In an aspect, the embodiments of the present disclosure provide a human-computer interaction apparatus, comprising:
a media data display module for displaying first media data in a first interface, wherein the first media data is media data that is currently playing;
a motion determination module for determining object motion information according to device posture data transmitted by a posture data acquisition device in response to a starting operation of a first service, wherein the first service includes interaction configuration information, and the interaction configuration information represents candidate object motion information and a candidate interaction mode;
an interaction module for determining a first interaction mode according to the object motion information and the interaction configuration information, and performing an interactive operation on the first media data according to the first interaction mode.

In an aspect, the embodiments of the present disclosure provide an electronic device, comprising:
one or more processors;
a storage apparatus for storing one or more programs,
the one or more programs, when executed by the one or more processors, causes the one or more processors to implement the human-computer interaction method of any of the embodiments of the present disclosure.

In an aspect, the embodiments of the present disclosure provide a non-transient computer-readable storage medium comprising computer-executable instructions, characterized in that the computer-executable instructions, when executed by a computer processor, are for performing the human-computer interaction method of any of the embodiments of the present disclosure.

### BRIEF DESCRIPTION OF DRAWINGS

The above and other features, advantages, and aspects of various embodiments of the present disclosure will become more apparent when taken in conjunction with the accompanying drawings and referring to of the following Detailed Description. Throughout the drawings, the same or similar reference numerals denote the same or similar elements. It should be understood that the drawings are schematic and that originals and elements are not necessarily drawn to scale.

FIG. 1 is a schematic flow diagram of a human-computer interaction method according to an embodiment of the present disclosure.

FIG. 2 is a schematic diagram of a first interface provided by an embodiment of the present disclosure.

FIG. 3 is a schematic diagram of turning of a video page turning according to an embodiment of the present disclosure.

FIG. 4 is a framework diagram of a human-computer interaction system according to an embodiment of the present disclosure.

FIG. 5 is a schematic flow diagram of another human-computer interaction method according to an embodiment of the present disclosure.

FIG. 6 is a schematic diagram of another first interface provided by an embodiment of the present disclosure.

FIG. 7 is a schematic diagram of still another first interface provided by an embodiment of the present disclosure.

FIG. 8 is a schematic structural diagram of a human-computer interaction apparatus according to an embodiment of the present disclosure.

FIG. 9 is a schematic structural diagram of an electronic device according to an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

Modifications of “one” and “more” mentioned in the present disclosure are schematic rather than restrictive, and those skilled in the art should understand that unless otherwise explicitly stated in the context, it should be understood as “one or more”.

The names of messages or information interacted between multiple apparatuses in embodiments of the present disclosure are for illustrative purposes only, and are not intended to limit the scope of these messages or information.

It can be understood that before using the technical solutions disclosed in respective embodiments of the present disclosure, users should be informed of the types, usage scopes, usage scenarios, etc. of the personal information involved in the present disclosure in an appropriate manner in accordance with relevant laws and regulations, and authorization from the users should be obtained.

For example, in response to receiving an active request from a user, a prompt message should be transmitted to the user to clearly prompt the user that the operation the user requested to be performed will require obtaining and using the user's personal information. Thus, the user can autonomously choose whether to provide personal information to software or hardware such as an electronic device, an application, a server, or a storage medium that performs the operations of the technical solution of the present disclosure according to the prompt message.

As an optional but non-limiting implementation, the way of sending prompt information to the user in response to receiving the active request from the user may be, for example, the way of a pop-up window, and the pop-up window may present prompt information by way of text. In addition, the pop-up window can also carry an optional control for the users to choose “agree” or “disagree” to provide personal information to the electronic device.

It can be understood that the above-described procedures of informing the user and obtaining user authorization are merely illustrative and do not limit the implementations of the present disclosure, and other methods satisfying relevant laws and regulations can also be applied to the implementation of the present disclosure.

It can be understood that the data involved in the present technical solution (including but not limited to the data itself, the acquisition or use of data) should comply with the requirements of corresponding laws, regulations and relevant provisions.

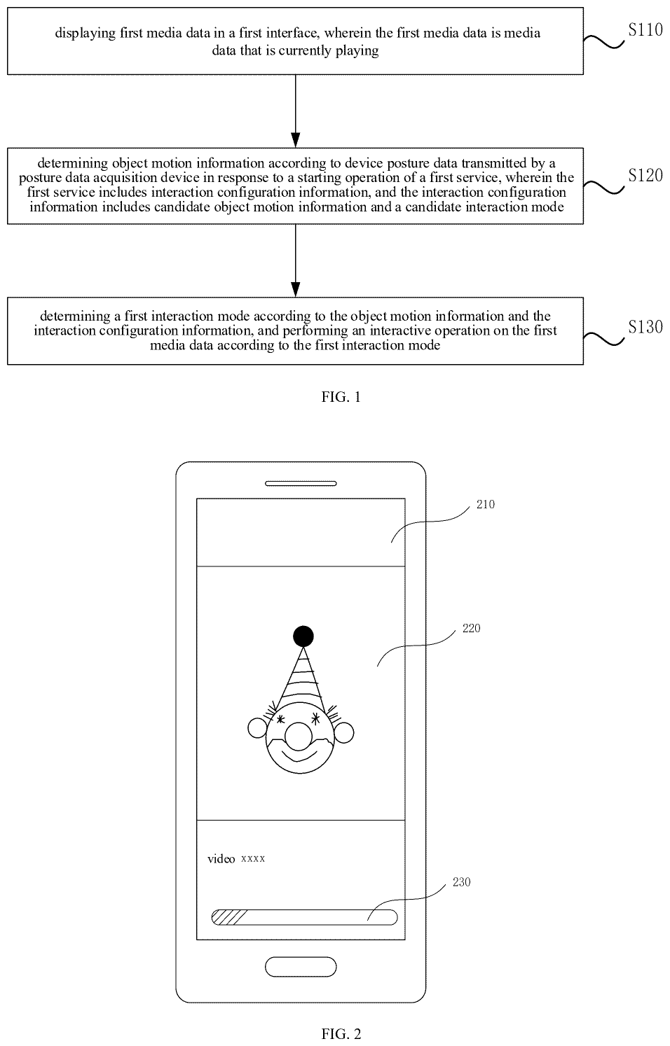

FIG. 1 is a schematic flow diagram of a human-computer interaction method according to an embodiment of the present disclosure, and the embodiment of the present disclosure is applicable to a situation in which a user watches media data, for example, a scenario in which human-computer interaction is realized by changing the user's posture. The method may be performed by a human-computer interaction apparatus, which may be implemented in the form of software and/or hardware, or optionally implemented by an electronic device, which may be a mobile terminal or a personal computer (PC) end, etc.

As shown in FIG. 1, the method comprises:

S110: Displaying first media data in a first interface, where the first media data is media data that is currently playing.

In an embodiment of the present disclosure, the first interface represents a medium through which the user interacts with the media data. For example, the first interface may be a user interface that displays first media data in a video application. The first media data is the media data that is currently playing in the first interface. Media data includes videos or pictures, etc.

FIG. 2 is a schematic diagram of a first interface provided by an embodiment of the present disclosure. As shown in FIG. 2, a video 220 and a progress bar 230 are shown in a first interface 210, and a playback progress of the video 220 is represented by a slash in the progress bar 230.

S120: in response to a starting operation of a first service, object motion information is determined according to device posture data transmitted by a posture data acquisition device, here, the first service includes interaction configuration information, and the interaction configuration information represents candidate object motion information and a candidate interaction mode.

Here, the first service represents the human-computer interaction service that depends on the object motion information. It can be understood that the first service is actively started by the user, and the target user has fully known relevant object motion information that the human-computer interaction service requires before starting the service. For example, the first service includes a service where videos are switched by head motion and/or a service where head interaction is performed through a first reminder notification, and the like. Video switching is a video page turning method, that is, the video that is currently playing is switched by video page turning. If the service of switching videos by head motion is started, the object motion information is determined from the device posture data to control the video switching according to the object motion information. The first reminder notification is used for reminding of performing object motion. Here, the object motion includes a head motion, an arm motion, and the like.

Device posture data is collected by a posture data acquisition device. In an embodiment of the present disclosure, the device posture data may include at least one of: a rotation rate of the device, a gravity vector, an acceleration, a magnetic field vector, a heading angle, a sensor position, and the like. Through the device posture data, the object motion information associated with the device can be determined. Here, the target motion information includes head motion information, or arm motion information, and the like. For headphones or in-ear headphones, etc., the head motion information can be determined from the headphone posture data. In the case of a hand-held user terminal, arm motion information and the like can be determined by the terminal posture data.

The posture data acquisition device may include a headphone integrated with an Inertial Measurement Unit (IMU) or the like. The IMU is usually configured in the headphone and is used to detect the headphone posture data after the user wears the headphone. For example, a pitch angle, a yaw angle, and a roll angle may be employed to represent the position and motion direction of the head. Here, the pitch angle is used to describe the rotation of the head in the vertical plane, that is, the angle of flipping up and down. A positive value indicates an upward flip and a negative value indicates a downward flip. The yaw angle is used to describe the rotation of the head in the horizontal plane, that is, the angle of turning the head left and right. A positive value indicates turning the head to the right and a negative value indicates turning the head to the left. The roll angle is used to describe the rotation of the head in the front-rear direction, that is, the angle of shaking the head. A positive value indicates a forward head shake and a negative value indicates a backward head shake.

The posture data acquisition device may further include a gyroscope in the user terminal for detecting the position and motion direction of the arm after the user holds the user terminal. For example, the translation in the coordinate axis may be employed to represent the position and motion direction of the arm. Translation along the X-axis indicates that the arm is moving in the horizontal direction, translation along the Y-axis indicates that the arm is moving in the vertical direction, and translation along the Z-axis indicates that the arm is moving in the front-rear direction.

The candidate object motion information and the candidate interaction mode may be a preconfigured interaction mode for representing the corresponding motion of the object. Here, candidate interaction modes may include turning the video page up, turning the video page down, turning the picture page up, turning the picture page down, updating the interaction progress or displaying first effects, etc. For example, the interaction configuration information may include that rotating the head in a vertical plane by an angle greater than or equal to a set angle controls the video page turning. Here, the head turning up (i.e., looking up) for a degree greater than xx controls to perform video page turning up, and the head turning down (i.e., looking down) for a degree smaller than cc controls to perform video page turning down. The interaction configuration information may also include that rotating the head by a set angle on the vertical plane and/or in the front-rear direction updates the interaction progress. Here, turning the head to the left for a degree of aa determines that one specified action is completed, and the interaction progress of the progress bar control is to be updated. Turning the head back for a degree of ss determines that another specified action is completed, and the interaction progress of the progress bar control is to be updated again.

Exemplarily, the first service is started according to a triggering operation of first control, device posture data transmitted by the posture data acquisition device is obtained, and the object motion information is determined according to the device posture data.

Specifically, the first control is used to turn on or off the service of switching videos through head motion. If the first control is triggered, the service of switching videos through head motion is turned on. Through a first interface provided by the posture data acquisition device, device posture data such as a rotation rate, a gravity vector, an acceleration, a magnetic field vector, a heading angle and a sensor position is obtained. The head rotation angle and the head rotation direction are determined according to the device posture data.

S130: Determining a first interaction mode according to the object motion information and the interaction configuration information, and performing an interactive operation on the first media data according to the first interaction mode.

Here, the first interaction mode may include a candidate interaction mode corresponding to the candidate object motion information matching the object motion information. That is, the object motion information is matched with the candidate object motion information in the interaction configuration information, and the candidate interaction mode corresponding to matched candidate object motion information is taken as the first interaction mode.

An interactive operation of the first media data represents the interactive operation with respect to the first media data, and may include that the object motion information controls video switching, or completing a guidance action leads to displaying the first effect at the corresponding position of the video, and the like.

Exemplarily, the object motion information is matched with the candidate object motion information to obtain a first interaction mode, here, the object motion information includes an object rotation angle and an object rotation direction. The switching of the first media data is controlled according to the first interaction mode.

For example, if the object moves vertically upward from a start position (i.e., looks up), the object motion information is data that changes in real time. When the object motion information remains unchanged, the object motion information can be matched with the candidate object of motion information to obtain the object interaction mode. Assuming that the matched candidate object motion information is looking up beyond a first angle, then the corresponding first interaction mode is turning up the video page, the first interaction mode is turning the video page up. If the head-up angle of the current object motion information is smaller than the first angle, then turning the video page up is not performed. When the head-up angle is greater than or equal to the first angle, turning the video page up is performed. If it is detected that the head has returned from the head-up state to the start position, no video page turning is performed. If it is detected again that the head-up angle is greater than or equal to the first angle, turning the video page up is performed again. If it is detected that the head has returned from the head-up state to the start position, no video page turning is performed. If it is detected that the head moves vertically downward from the start position (that is, looks down), the object motion information is matched with the candidate object motion information to obtain the first interaction mode. Assuming that the matched candidate object motion information is lowering the head no more than a second angle, the corresponding first interaction mode is turning the video page down. If the head-down angle of the current object motion information is greater than the second angle, turning the video page down is not performed. When the head-down angle is smaller than or equal to the second angle, turning the video page down is performed. If it is detected that the head returns from the head-down state to the start position, no video page turning is performed. If it is detected again that the head-down angle is smaller than or equal to the second angle, turning the video page down is performed again.

Since the user can't intuitively observe the motion information of his/her head, the motion state of the slider in the control bar in the first interface can be used to represent the head motion information. Optionally, after determining the object motion information according to the device posture data transmitted by the posture data acquisition device, the followings are further performed: displaying a motion information display control in the first interface, the motion information display control including a control bar and a slider, and the slider reciprocating within the control bar according to the object motion information. For example, the position and orientation of the slider within the control bar are adjusted in real time according to the rotation angle and rotation mode of the head, so that the slider reciprocates within the control bar. Specifically, a corresponding relationship between the angular range of the pitch angle of the head motion and the length of the control bar may be established, and then the object motion information may be determined according to the device posture data collected in real time, and the position and direction of the slider in the control bar may be adjusted in real time according to the object motion information. If the object motion information represents a motion process of raising the head up to a degree of xx and then returning to the original position, the motion of the slider follows the motion of the head, to move upward from the central position of the control bar to the distance corresponding to the head-up angle, and then returning to the central position of the control bar. If the object motion information represents the motion process of lowering the head to a degree of cc and then returning to the original position, the motion of the slider follows the motion of the head to realize the downward motion from the central position of the control bar to the distance corresponding to the head-up angle, and then returning to the central position of the control bar.

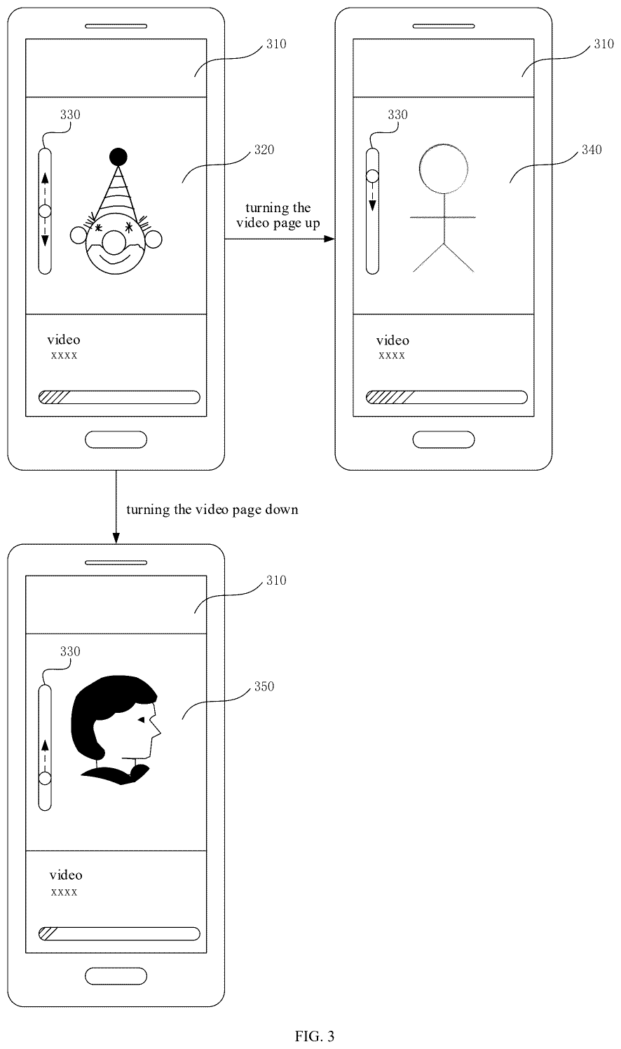

FIG. 3 is a schematic diagram of video page turning according to an embodiment of the present disclosure. In the figure, an arrow moving upward and away from the central position of the control bar indicates looking up, and an arrow moving downward and approaching the central position of the control bar indicates looking down and then returning to the original position. An arrow moving downward and away from the central position of the control bar indicates looking down, and an arrow moving upward and approaching the central position of the control bar indicates looking down and then returning to the original position. As shown in FIG. 3, the first interface 310 displays a first video 320 and a motion information display control 330, and in the motion information display control 330, the slider is located at the central position of the control bar. If the object motion information represents a motion process of raising the head to a degree of xx and then returning to the original position, then when the head is raised to a degree of xx, an operation of turning the video page up is performed, to display the second video 340 on the first interface 310. The motion of the slider follows the motion of the head, and the motion information display control 330 is displayed at the position corresponding to the first video 320, and the slider moves upward from the central position of the control bar until the distance corresponding to the head-up angle is reached. The motion information display control 330 is displayed at the position corresponding to the second video 340, and the slider moves upward from the distance corresponding to the head-up angle until it returns to the central position of the control bar.

The first video 320 is displayed in the current first interface 310, and if the object motion information represents the motion process of lowering the head to a degree of cc and then returning to the original position, when the head is lowered to a degree of cc, the operation of turning the video page down is performed, to display the third video 350 in the first interface 310. The motion of the slider follows the motion of the head, and the motion information display control 330 is displayed at the position corresponding to the first video 320, and the slider moves downward from the central position of the control bar until the distance corresponding to the head-down angle is reached. The motion information display control 330 is displayed at the position corresponding to the third video 350, the slider moves upward from the distance corresponding to the head-down angle until it returns to the central position of the control bar.

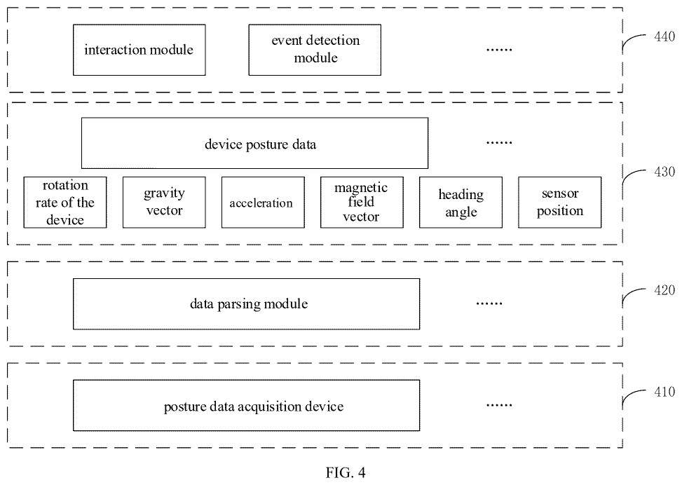

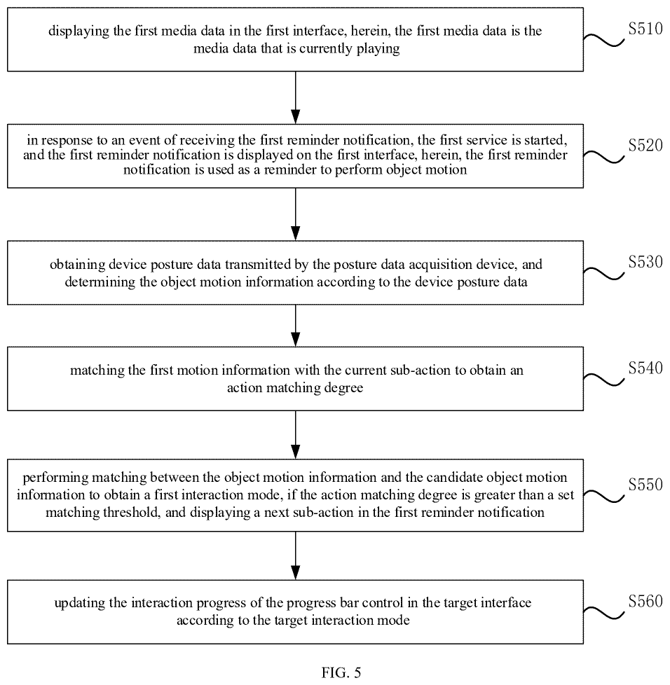

FIG. 4 is a framework diagram of a human-computer interaction system according to an embodiment of the present disclosure. As shown in FIG. 4, the human-computer interaction system includes a physical layer 410, a data processing layer 420, a data layer 430, and an application layer 440. Here, the physical layer 410 includes a posture data acquisition device and belongs to the headphone end. The data processing layer 420, the data layer 430 and the application layer 440 are the client's logical layers. The data processing layer 420 includes a data parsing module. The data layer 430 includes device posture data. The application layer 440 includes an interaction module and an event detection module. The application layer 440 detects connection events and disconnection events of the headphone in real time. After the headphone is connected, the data processing layer 420 receives the head tracking data reported by the physical layer, and parses the head tracking data to obtain the device posture data. The device posture data is used to constitute the data layer 430. The application layer 440 determines the object motion information according to the device posture data, and performs human-computer interaction according to the first interaction mode corresponding to object the motion information.

Optionally, the device posture data may also be acquired through the posture data acquisition device on the user terminal. For example, the posture data of the mobile phone can be obtained through a gyroscope on the mobile phone, and the arm movement information can be determined according to the posture data of the mobile phone. Accordingly, the interaction configuration information may include moving the arm forward and backward in the z-axis direction to control the turning of the video page. Moving forward by more than or equal to ff centimeters controls the video page turning up, and moving backward by smaller than or equal to bb centimeters controls the video page turning down.

In the technical solution of the embodiment of the present disclosure, by determining the object motion information according to the device posture data transmitted by the posture data acquisition device in response to the starting operation of the first service, then determining the first interaction mode according to the object motion information and interaction configuration information, and performing the interactive operation on the first media data according to the first interaction mode, human-computer interaction is controlled based on different motion information of the object, thus preventing the user from being in the same posture for a long time, and guiding the user to exercise appropriately and use the applications healthily and moderately.

FIG. 5 is a schematic flow diagram of another human-computer interaction method provided by an embodiment of the present disclosure. On the basis of the above embodiments, the embodiment of the present disclosure defines that the first service is started by the first reminder notification. As shown in FIG. 5, the method comprises:

S510: displaying the first media data in the first interface, herein, the first media data is the media data that is currently playing.

S520: in response to an event of receiving the first reminder notification, the first service is started, and the first reminder notification is displayed on the first interface, herein, the first reminder notification is used as a reminder to perform object motion.

Here, the first reminder notification includes action guidance information and a progress bar control, etc., and the motion guidance information includes at least one sub-action. The motion guidance information may include designated motions beneficial to the cervical spine, etc. For example, the designated motion may include a motion specified for cervical exercise or the like. The progress bar control is used to represent the user's completion of the specified actions in the action guidance information. Optionally, the progress bar control may be a control that presents the progress of the interaction in the first reminder notification. The first reminder notification can be in the form of a notification pop-up window, and the content of the first reminder notification, the guidance information, and the progress bar, etc. are displayed in the notification pop-up window.

Optionally, the first reminder notification represents a system notification message or a notification message transmitted by other user terminals in a same group. For example, after the headphones are connected, the user terminal may determine the posture data differences among the headphone posture data collected at different time points. If the posture data differences among the adjacent acquisition time points within the set time period is less than the set difference threshold, it is determined that the user has been in the same posture for a long time, and a first reminder notification is generated, and the first reminder notification is the system notification message.

Alternatively, a first reminder notification transmitted by other user terminals in the same target group is obtained. Accordingly, the user account number and the user avatar corresponding to the user terminal that transmits the first reminder notification are displayed in the notification pop-up window, to identify the friend who transmits the first reminder notification. Through the reminder between friends, the frequency of interaction among friends is increased, and the probability of users responding to first reminder notifications is increased.

Optionally, after obtaining the first reminder notification, the client displays the first reminder notification at a position corresponding to the first media data in the first interface, so that the user can intuitively see the first reminder notification. Further, the probability that the user responds to the first reminder notification is increased.

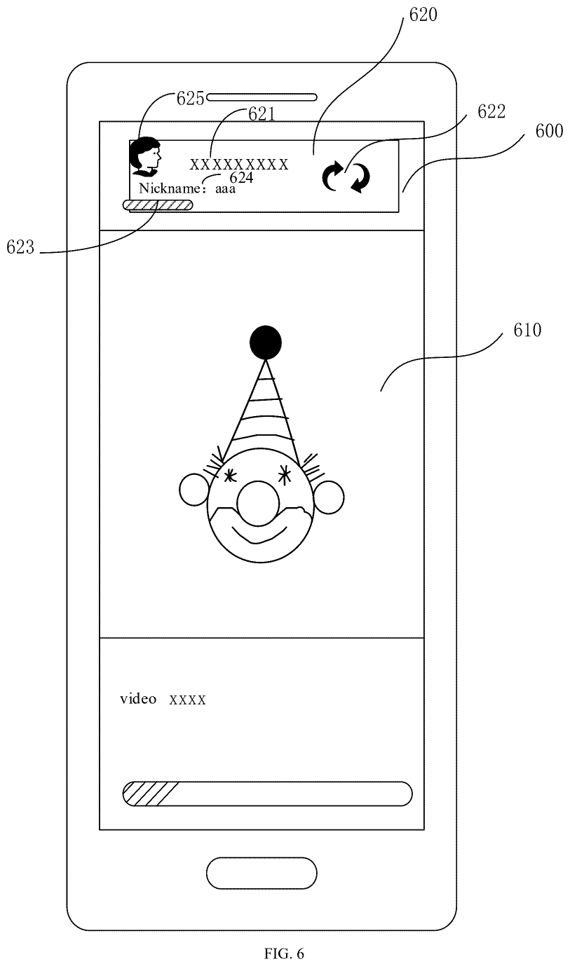

FIG. 6 is a schematic diagram of another first interface provided by an embodiment of the present disclosure. As shown in FIG. 6, a first reminder notification 620 is displayed at a position corresponding to the target video 610 in the first interface 600. The first reminder notification 620 includes first reminder notification content 621, guidance information 622, a progress bar control 623, a user account 624, and a user avatar 625, etc.

S530: obtaining device posture data transmitted by the posture data acquisition device, and determining the object motion information according to the device posture data.

S540: matching the target motion information with the current sub-action to obtain an action matching degree.

Since the motion guidance information may include more than one sub-action, the user needs to complete respective sub-actions one by one.

In the embodiment of the present disclosure, the decomposition action of the motion guidance information is displayed by the first reminder notification, that is, the sub-actions of the motion guidance information are displayed one by one, so that the user can better complete the actions. When the object motion information matches the current sub-action, it is considered that the user has completed the sub-action, the interaction progress can be updated, and the next sub-action can be displayed.

Alternatively, respective sub-actions may be continuously displayed through the motion guidance information, and the interaction progress may be updated when the user completes one sub-action.

The action matching degree may represent the consistency between the rotation direction of the object motion information and the current sub-action. The rotation direction in the object motion information is matched with the current sub-action, and if they are consistent in direction, the action matching degree is determined to be 1, otherwise, the action matching degree is determined to be 0.

S550: performing matching between the object motion information and the candidate object motion information to obtain a first interaction mode, if the action matching degree is greater than a set matching threshold, and displaying a next sub-action in the first reminder notification.

In an embodiment of the present disclosure, the first interaction mode may include an interaction mode corresponding to a result of matching between the object motion information and the candidate object motion information. If there is candidate object motion information that matches the object motion information, it is determined that the first interaction mode is interaction progress updating. If there is no candidate object motion information matching the object motion information, it is determined that the first interaction mode is giving up the interaction progress updating.

Since the action matching degree is smaller than the set matching threshold, which is usually a case where the rotation direction of the target motion information is inconsistent with that of the current sub-action, and in this case, it can be determined that the user has not completed the designated action and does not need to continue the first interaction mode. The current sub-action may be repeatedly displayed through the first reminder notification to guide the user to make the correct action. Alternatively, the user is prompted by an error message pop-up window of a rotation direction error, etc.

If the action matching degree is greater than the set matching threshold, it is determined that the rotation direction of the object motion information is consistent with that of the current sub-action, and it can be continued to match the object motion information and the candidate object motion information in two dimensions including the rotation direction and the rotation angle, so that the candidate interaction mode corresponding to matched candidate object motion information is used as the first interaction mode. Specifically, the first interaction mode may be interaction progress updating. If there is candidate object mode information matching the object motion information, the first interaction mode is interaction progress updating. If there is no candidate object motion information matching the object motion information, the first interaction mode is giving up the interaction progress updating.

Since it is determined that the rotation direction of the object motion information is consistent with that of the current sub-action, the next sub-action may be displayed through the first reminder notification.

It is assumed that the motion guidance information is that the head turns from left to right, and then from right to left. The motion guidance information can be decomposed into three sub-actions. The first sub-action is turning the head to the left, the second sub-action is turning the head to the right, and the third sub-action is turning the head to the left again. If it is determined that the user has completed the first sub-action through rotation direction matching, the first interaction mode is determined according to the result of matching between the object motion information corresponding to the first sub-action and the candidate object motion information. If the matching is successful, the interaction progress of the progress bar control will be updated. If it is determined that the user has completed the second sub-action through rotation direction matching, the first interaction mode is determined according to the result of matching between the object motion information corresponding to the second sub-action and the candidate object motion information. If the matching is successful, the interaction progress of the progress bar control will be updated again.

Optionally, if the action matching degree is greater than the set matching threshold, the object motion information and the candidate object motion information are matched to obtain a first interaction mode.

Optionally, if the action matching degree is greater than the set matching threshold, the next sub-action is displayed in the first reminder notification.

S560: updating the interaction progress of the progress bar control in the first interface according to the first interaction mode.

In an embodiment of the present disclosure, the number of sub-actions included in the motion guidance information divides the interaction progress of the progress bar control into a corresponding number of sub-segments. Whenever a sub-action is completed and the first interaction mode is interaction progress updating, the sub-segment of the interaction progress of the progress bar control is incremented by one. It should be noted that if a sub-action is completed and the first interaction mode is to abandon updating the interaction progress, then updating the interaction progress of progress bar control is abandoned. If a sub-action is not completed, updating the interactive progress of the progress bar control will also be abandoned.

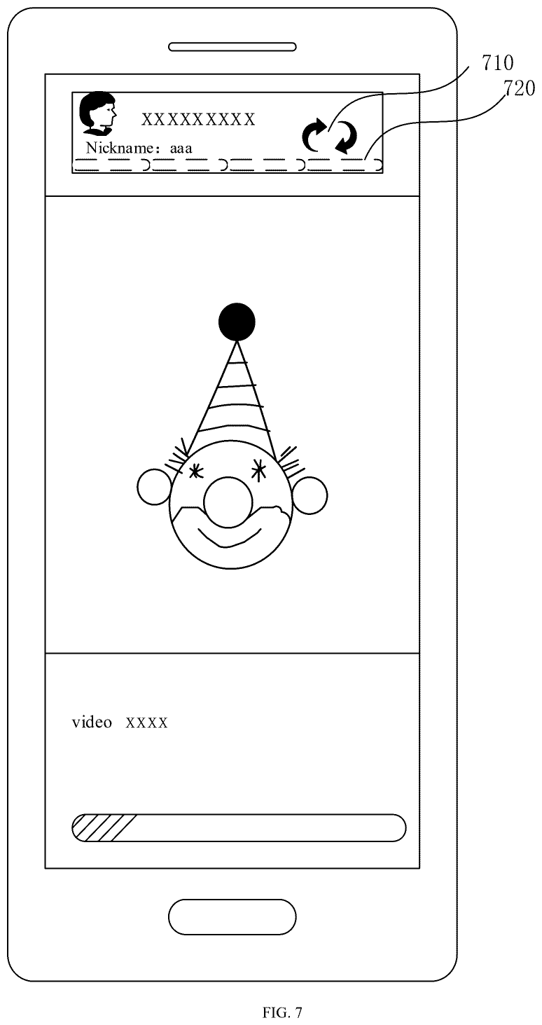

FIG. 7 is a schematic diagram of another first interface provided by an embodiment of the present disclosure. As shown in FIG. 7, the motion guidance information 710 is that the head turns from left to right, then turns from right to rear, and then turns from rear to left. The motion guidance information can be decomposed into four sub-actions. Accordingly, the interaction progress of the progress bar control 720 is divided into 4 sub-segments (indicated by dashed lines), each sub-segment representing 25%. If the object motion information is turning the head to the left by a degree of z1, which is consistent with the rotation direction of the first sub-action, the object motion information is matched with the candidate interaction modes in the interaction configuration information, and if there is candidate object motion information of turning the head to the left by a degree of z1, then the first interaction mode is determined to be a sub-segment in which the interaction progress increases. That is, the interaction progress of the progress bar control 720 is 25%. If the object motion information is turning the head to the right by a degree of z2, which is consistent with the rotation direction of the second sub-action, the object motion information is matched with the candidate interaction modes in the interaction configuration information, and if there is candidate object motion information of turning the head to the right by a degree of z2, the first interaction mode is determined to be a sub-segment in which the interaction progress increases. That is, the interaction progress of the progress bar control 720 is 50%. If the object motion information is turning the head to the left by a degree of z3, which is inconsistent with the rotation direction of the third sub-action of the motion guidance information, updating the interaction progress of the progress bar control 720 is abandoned, and the interaction progress is kept at 50%. An error prompt notification 730 is displayed at a corresponding position of the target video to prompt the user of a rotation direction error.

S570: If the interaction progress meets a preset end condition, the first reminder notification is turned off, and first effect is displayed at a position corresponding to the first media data.

Here, the first effect is image materials having a specific effect in rendering at a position corresponding to the first media data. Displaying the first effect at the position corresponding to the first media data can stimulate the user's behavior of responding to the first reminder notification, and improve the user's enthusiasm for responding to the first reminder notification again, and thus preventing the user from being in the same posture for a long time.

The preset end condition is used for determining whether the user completes a sub-action included in the motion guidance information. Status information of the interaction progress in the progress bar control can be used to determine whether the user has completed the sub-actions included in the sports guidance information. If the interaction progress in the progress bar control is 100%, it is determined that the user has completed the sub-actions included in the sports guidance information, that is, the interaction progress meets the preset end condition.

For example, if the interaction progress is 100%, the notification pop-up window corresponding to the first reminder notification is turned off, and the first effect is displayed at the position corresponding to the first media data.

Optionally, if the interaction progress meets the preset end condition, the first reminder notification is turned off.

Optionally, if the interaction progress meets a preset end condition, the first effect is displayed at a position corresponding to the first media data.

According to the technical solution of the embodiment of the present disclosure, the user is guided to perform specified actions through the first reminder notification, and the interaction progress is displayed at the position corresponding to the first media data, and when the interaction progress meets the preset end condition, the first effect is displayed, so that the positive incentive mode is adopted to improve the enthusiasm of the user in responding to the first reminder notification, the interaction mode is enriched, and the user is prevented from being in the same posture for a long time.

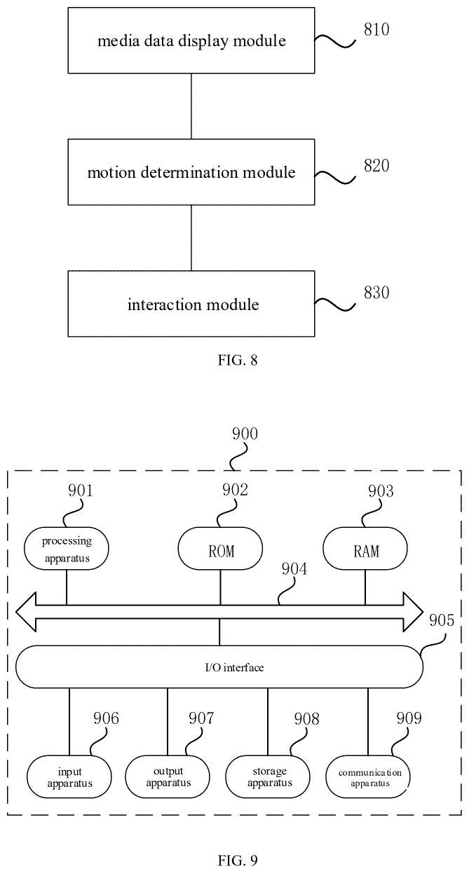

FIG. 8 is a schematic structural diagram of a human-computer interaction apparatus according to an embodiment of the present disclosure, and the apparatus may be implemented in the form of software and/or hardware, or optionally, by an electronic device, and the electronic device may be a mobile terminal, a PC end, or the like.

As shown in FIG. 8, the apparatus includes a media data display module 810, a motion determination module 820, and an interaction module 830.

The media data display module 810 is configured to display first media data in a first interface, herein, the first media data is the media data that is currently playing;

The motion determination module 820 is configured to determine object motion information according to device posture data transmitted by a posture data acquisition device in response to a starting operation of a first service, here, the first service includes interaction configuration information, and the interaction configuration information represents candidate object motion information and a candidate interaction mode;

The interaction module 830 is configured to determine a first interaction mode according to the object motion information and the interaction configuration information, and perform an interactive operation on the first media data according to the first interaction mode.

Optionally, the motion determination module 820 is specifically configured to:

Start the first service according to a triggering operation of a first control, acquire the device posture data transmitted by the posture data acquisition device, and determine the object motion information according to the device posture data.

Optionally, the apparatus further comprises:

a motion information display module, configured to display a motion information display control in the first interface, after determining the object motion information according to the device posture data transmitted by the posture data acquisition device. The motion information display control comprises a control bar and a slider reciprocating within the control bar according to the object motion information

Optionally, the interaction module 830 is specifically configured to:
obtain a first interaction mode by matching the object motion information with the candidate object motion information, here, the object motion information includes an object rotation angle and an object rotation direction; and
control the switching of the first media data according to the first interaction mode.

Optionally, the motion determination module 820 is specifically configured to start the first service in response to an event of receiving a first reminder notification, and display
the first reminder notification in the first interface, here, the first reminder notification is used as a reminder of performing an object motion;
obtain the device posture data transmitted by the posture data acquisition device, and determine the object motion information according to the device posture data.

Optionally, the first reminder notification comprises motion guidance information and a progress bar control, and the motion guidance information comprises at least one sub-action.

Optionally, the interaction module 830 is specifically configured to
obtain an action matching degree by matching the object motion information with a current sub-action;
obtain the first interaction mode by matching the object motion information and the candidate object motion information if the action matching degree is greater than a set matching threshold, and/or display a next sub-action in the first reminder notification.

Optionally, the interaction module 830 is specifically configured to
update an interaction progress of the progress bar control in the first interface according to the first interaction mode;
turn off the first reminder notification if the interaction progress meets a preset end condition, and/or display a first effect at a position corresponding to the first media data.

Optionally, the first reminder notification represents a system notification message or a notification message transmitted by other user terminals in a same group.

The human-computer interaction apparatus according to the embodiments of the present disclosure can execute the human-computer interaction method according to any embodiment of the present disclosure, and has functional modules and beneficial effects corresponding to the execution of the method.

It is worth noting that respective units and modules included in the above-described apparatus are divided according to the functional logic, but are not limited to the above-described division, as long as the corresponding functions can be realized; In addition, the specific names of respective functional units are only for convenience of mutual distinction, and are not used to limit the scope of protection of the embodiments of the present disclosure.

FIG. 9 is a schematic structural diagram of an electronic device according to an embodiment of the present disclosure. FIG. 9 is specifically referred below, and it shows the structure schematic diagram suitable for achieving the electronic device 900 (e.g., the terminal device in FIG. 9) in the embodiment of the present disclosure. The electronic device 900 in the embodiment of the present disclosure may include but not be limited to a mobile terminal such as a mobile phone, a notebook computer, a digital broadcasting receiver, a personal digital assistant (PDA), a PAD (tablet computer), a portable multimedia player (PMP), a vehicle terminal (such as a vehicle navigation terminal), and a fixed terminal such as a digital television (TV) and a desktop computer. The electronic device shown in FIG. 9 is only an example and should not impose any limitations on the functions and use scopes of the embodiments of the present disclosure.

As shown in FIG. 9, the electronic device 900 may include a processing apparatus (such as a central processing unit, and a graphics processor) 901, it may execute various appropriate actions and processes according to a program stored in a read-only memory (ROM) 902 or a program loaded from a storage apparatus 908 to a random access memory (RAM) 903. In RAM 903, various programs and data required for operations of the electronic device 900 are also stored. The processing apparatus 901, ROM 902, and RAM 903 are connected to each other by a bus 904. An input/output (I/O) interface 905 is also connected to the bus 904.

Typically, the following apparatuses may be connected to the I/O interface 905: an input apparatus 906 such as a touch screen, a touchpad, a keyboard, a mouse, a camera, a microphone, an accelerometer, and a gyroscope; an output apparatus 907 such as a liquid crystal display (LCD), a loudspeaker, and a vibrator; a storage apparatus 908 such as a magnetic tape, and a hard disk drive; and a communication apparatus 909. The communication apparatus 909 may allow the electronic device 900 to wireless-communicate or wire-communicate with other devices so as to exchange data. Although FIG. 9 shows the electronic device 900 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 909, or installed from the storage apparatus 908, or installed from ROM 902. When the computer program is executed by the processing apparatus 901, the above functions defined in the methods in the embodiments of the present disclosure are executed.

The names of messages or information interacted between multiple devices in embodiments of the present disclosure are for illustrative purposes only, and are not intended to limit the scope of these messages or information.

The electronic device provided by the embodiment of the present disclosure and the human-computer interaction method provided by the above embodiment belong to the same inventive concept, and the technical details not described in detail in the present embodiment can be referred to in the above embodiments, and the present embodiment has the same beneficial effects as the above embodiments.

Embodiments of the present disclosure provide a computer storage medium storing computer programs thereon, and the programs, when executed by the processor, implement the human-computer interaction method provided by the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
display first media data in a first interface, here, the first media data is media data that is currently playing;
determine object motion information according to device posture data transmitted by a posture data acquisition device in response to a starting operation of a first service, here, the first service includes interaction configuration information, and the interaction configuration information represents candidate object motion information and a candidate interaction mode;
determine a first interaction mode according to the object motion information and the interaction configuration information, and perform an interactive operation on the first media data according to the first interaction mode.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A human-computer interaction method, comprising:
displaying first media data in a first interface, wherein the first media data is media data that is currently playing;
determining object motion information according to device posture data transmitted by a posture data acquisition device in response to a starting operation of a first service, wherein the first service includes interaction configuration information, and the interaction configuration information represents candidate object motion information and a candidate interaction mode;
determining a first interaction mode according to the object motion information and the interaction configuration information, and performing an interactive operation on the first media data according to the first interaction mode.

2. The method according to claim 1, wherein, the determining the object motion information according to the device posture data transmitted by the posture data acquisition device in response to the starting operation of the first service comprises:
starting the first service according to a triggering operation of a first control, acquiring the device posture data transmitted by the posture data acquisition device, and determining the object motion information according to the device posture data.

3. The method of claim 1, wherein, after determining the object motion information according to the device posture data transmitted by the posture data acquisition device, the method further comprises:
displaying a motion information display control in the first interface, the motion information display control comprising a control bar and a slider reciprocating within the control bar according to the object motion information.

4. The method of claim 1, wherein, the determining the first interaction mode according to the object motion information and the interaction configuration information, and performing the interactive operation on the first media data according to the first interaction mode, comprises:
obtaining a first interaction mode by matching the object motion information with the candidate object motion information, wherein the object motion information includes an object rotation angle and an object rotation direction; and
switching the first media data according to the first interaction mode.

5. The method according to claim 1, wherein, the determining the object motion information according to the device posture data transmitted by the posture data acquisition device in response to the starting operation of the first service comprises:
starting the first service in response to an event of receiving a first reminder notification, and displaying the first reminder notification in the first interface, wherein the first reminder notification is used as a reminder of performing an object motion; and
obtaining the device posture data transmitted by the posture data acquisition device, and determining the object motion information according to the device posture data.

6. The method of claim 5, wherein, the first reminder notification comprises motion guidance information and a progress bar control, and the motion guidance information comprises at least one sub-action.

7. The method of claim 6, wherein, the determining the first interaction mode according to the object motion information and the interaction configuration information comprises:
obtaining an action matching degree by matching the object motion information with a current sub-action; and
obtaining the first interaction mode by matching the object motion information and the candidate object motion information if the action matching degree is greater than a set matching threshold, or displaying a next sub-action in the first reminder notification.

8. The method of claim 6, wherein, the performing the interactive operation on the first media data according to the first interaction mode comprises:
updating an interaction progress of the progress bar control in the first interface according to the first interaction mode; and
turning off the first reminder notification if the interaction progress meets a preset end condition, or displaying a first effect at a position corresponding to the first media data.

9. The method according to claim 5, wherein, the first reminder notification represents a system notification message or a notification message transmitted by other user terminals in a same group.

10. An electronic device, comprising:
one or more processors;
a storage apparatus for storing one or more programs,
wherein the one or more programs, when executed by the one or more processors, cause the one or more processors to implement a human-computer interaction method, the human-computer interaction method comprising:
displaying first media data in a first interface, wherein the first media data is media data that is currently playing;
determining object motion information according to device posture data transmitted by a posture data acquisition device in response to a starting operation of a first service, wherein the first service includes interaction configuration information, and the interaction configuration information represents candidate object motion information and a candidate interaction mode;
determining a first interaction mode according to the object motion information and the interaction configuration information, and performing an interactive operation on the first media data according to the first interaction mode.

11. The electronic device according to claim 10, wherein, the determining the object motion information according to the device posture data transmitted by the posture data acquisition device in response to the starting operation of the first service comprises:
starting the first service according to a triggering operation of a first control, acquiring the device posture data transmitted by the posture data acquisition device, and determining the object motion information according to the device posture data.

12. The electronic device of claim 10, wherein, after determining the object motion information according to the device posture data transmitted by the posture data acquisition device, the method further comprises:
displaying a motion information display control in the first interface, the motion information display control comprising a control bar and a slider reciprocating within the control bar according to the object motion information.

13. The electronic device of claim 10, wherein, the determining the first interaction mode according to the object motion information and the interaction configuration information, and performing the interactive operation on the first media data according to the first interaction mode, comprises:
obtaining a first interaction mode by matching the object motion information with the candidate object motion information, wherein the object motion information includes an object rotation angle and an object rotation direction; and
switching the first media data according to the first interaction mode.

14. The electronic device according to claim 10, wherein, the determining the object motion information according to the device posture data transmitted by the posture data acquisition device in response to the starting operation of the first service comprises:
starting the first service in response to an event of receiving a first reminder notification, and displaying the first reminder notification in the first interface, wherein the first reminder notification is used as a reminder of performing an object motion;
obtaining the device posture data transmitted by the posture data acquisition device, and determining the object motion information according to the device posture data.

15. The electronic device of claim 14, wherein, the first reminder notification comprises motion guidance information and a progress bar control, and the motion guidance information comprises at least one sub-action.

16. The electronic device of claim 15, wherein, the determining the first interaction mode according to the object motion information and the interaction configuration information comprises:
obtaining an action matching degree by matching the object motion information with a current sub-action;
obtaining the first interaction mode by matching the object motion information and the candidate object motion information if the action matching degree is greater than a set matching threshold, or displaying a next sub-action in the first reminder notification.

17. The electronic device of claim 15, wherein, the performing the interactive operation on the first media data according to the first interaction mode comprises:
updating an interaction progress of the progress bar control in the first interface according to the first interaction mode;
turning off the first reminder notification if the interaction progress meets a preset end condition, or displaying a first effect at a position corresponding to the first media data.

18. The electronic device according to claim 14, wherein, the first reminder notification represents a system notification message or a notification message transmitted by other user terminals in a same group.

19. A non-transient computer-readable storage medium comprising computer-executable instructions, the computer-executable instructions, when executed by a computer processor, are for performing a human-computer interaction method, the human-computer interaction method comprising:
displaying first media data in a first interface, wherein the first media data is media data that is currently playing;
determining object motion information according to device posture data transmitted by a posture data acquisition device in response to a starting operation of a first service, wherein the first service includes interaction configuration information, and the interaction configuration information represents candidate object motion information and a candidate interaction mode;
determining a first interaction mode according to the object motion information and the interaction configuration information, and performing an interactive operation on the first media data according to the first interaction mode.

20. The non-transient computer-readable storage medium according to claim 19, wherein, the determining the object motion information according to the device posture data transmitted by the posture data acquisition device in response to the starting operation of the first service comprises:
starting the first service according to a triggering operation of a first control, acquiring the device posture data transmitted by the posture data acquisition device, and determining the object motion information according to the device posture data.
